(19) United States
(12) Patent Application Publication
(10) Pub. No.: US 2019/0082498 A1
(43) Pub. Date: Mar. 14, 2019

(54) ULTRA LOW POWER SUB-WIRELESS SENSOR NETWORK (SUB-WSN) FOR INTERNET OF THINGS (IOT) SYSTEM

(71) Applicant: Brocere Electronics company limited, New Taipei City (TW)

(72) Inventors: Chih-Hao Lai, Taipei City (TW); Jou-Hung Wang, Taipei City (TW); Ting-An Yen, Taipei City (TW)

(21) Appl. No.: 15/701,460

(22) Filed: Sep. 12, 2017

(51) Int. Cl. H04W 88/16; H04W 4/00

(52) U.S. Cl. CPC H04W 88/16; H04L 67/2895; H04W 4/005

(57) ABSTRACT

The present invention provides a sub-WSN for an IoT system having at least a sensor node, and a sub-sensor node and a sub-gateway for the sub-WSN, so as to solve the problems of low channel quantity and high power consumption in the prior art. The sub-WSN comprises: a sub-gateway and a plurality of sub-sensor nodes. The sub-gateway is wiredly coupled to the Sensor node. The sub-sensor nodes are utilized for sensing and wirelessly communicating with the sub-gateway via RF signals.

### BACKGROUND OF THE INVENTION

### 1. Field of the Invention

The present invention relates to a sub-Wireless Sensor Network (sub-WSN), and more particularly, to an ultra low power sub-WSN for an Internet of Things (IoT) system having at least a sensor node, and a sub-sensor node and a sub-gateway for the sub-WSN.

### 2. Description of the Prior Art

Please refer to FIG. 1. FIG. 1 is a simplified block diagram of a conventional Internet of Things (IoT) system 100. As shown in FIG. 1, the IoT system 100 comprises: a Wireless Sensor Network (WSN) 101 and a cloud server 102. The WSN 101 comprises: a gateway 110, and three Sensor nodes 120, wherein the gateway 110 and the Sensor nodes 120 can be Bluetooth devices, ZigBee devices, WiFi devices, 6LowPAN devices, LoRa devices, or Sub-1 GHz devices, etc. The gateway 110 has a transceiver 112 and each sensor node 120 has a transceiver 122 for communication. However, the traditional (standard) WSN 101 in the IoT system 100 has problems of limited channel quantity and too large power consumption for battery-less applications.

For example, when the IoT system 100 is applied to sense temperature of a number N of solar panels, if N=20, then a number 20 of sensor nodes 120 are required in the WSN 101. Suppose the gateway 110 only has a limited channel quantity (for example, the gateway 110 only has 10 channels in a 2.4 G communication system), the WSN 101 requires two gateways 110 and twenty sensor nodes 120 to sense temperature of twenty solar panels.

Besides, since the gateway 110 and the sensor nodes 120 of standard sensor nodes have high power consumption more than 1 mW power which couldn't be easily applied to battery-less applications, (for example, RF power harvest only can generate 1˜10 uW but couldn't support the standard WSN 101) and require batteries for normal operation.

The above 2 drawbacks of current standard WSN 101 limit the development of IoT product.

### SUMMARY OF THE INVENTION

It is therefore one of the objectives of the present invention to provide a ultra low power sub-wireless sensor network (sub-WSN) for an Internet of Things (IoT) system having at least a sensor node, which comprises at least a sub-sensor node and a sub-gateway, so as to solve the problems of limited channel quantity and high power consumption in the prior art.

According to a first aspect of the present invention, an exemplary sub-WSN for an IoT system having at least a sensor node is disclosed. The exemplary sub-WSN comprises: a sub-gateway and a plurality of sub-sensor nodes. The sub-gateway is wiredly coupled to the standard Sensor node. The sub-sensor nodes are utilized for sensing and wirelessly communicating with the sub-gateway via RF signals.

According to a second aspect of the present invention, an exemplary sub-sensor node for a sub-WSN is disclosed. The exemplary sub-sensor node comprises: a sensor unit, a processing unit, a transmitter unit, and a receiver unit. The sensor unit is utilized for sensing to generate sensing values. The processing unit is coupled to the sensor unit, and utilized for processing the sensing values to generate data. The transmitter unit is coupled to the processing unit, and utilized for transmitting the data to a sub-gateway of the sub-WSN. The receiver unit is coupled to the processing unit, and utilized for receiving signals from the sub-gateway.

According to a second aspect of the present invention, an exemplary sub-gateway for a sub-WSN is disclosed. The exemplary sub-gateway comprises: a receiver unit and a processing unit. The receiver unit is utilized for receiving data from a plurality of sub-sensor nodes of the sub-WSN. The processing unit is coupled to the receiver unit, and utilized for processing the data.

For example, when the IoT system is applied to sense temperature of a number N of solar panels and N=20, the present invention can provide a sub-WSN having two sub-gateways and twenty sub-sensor nodes for a sensor node of the WSN in the IoT system. Please note that the wireless communication between the sub-gateway and the sub-sensor nodes is an ultra low power proprietary RF transceiver architecture such as a 27 MHz proprietary RF transceiver architecture, which uses different frequency from standard RF in WSN and has more flexible channels for transmission. Besides, the power consumption of the sub-gateway and the sub-sensor nodes can be very low (for example, lower than 1 micro watt). Therefore, the sub-WSN can be applied to battery-less applications (for example, RF power harvest only can generate 1˜10 uW and can support the sub-gateway and the sub-sensor nodes in the sub-WSN). In this way, only one sensor node is required for this scenario, and thus the problems of limited channel quantity and high power consumption of the WSN in the IoT system in the prior art are solved by this ultra low power sub-WSN. Briefly summarized, the ultra low power sub-WSN, and the sub-sensor node and the sub-gateway for the sub-WSN disclosed by the present invention can solve the problems of limited channel quantity and high power consumption of the WSN in the IoT system in the prior art, and can reduce cost accordingly. In addition, since the sub-WSN does not use the frequency of the WSN (for example, the sub-gateway operates without using the transceiver of the sensor node in the WSN), the bandwidth of the WSN is not occupied by the sub-WSN.

Briefly summarized, the ultra low power sub-WSN, and the sub-sensor node and the sub-gateway for the sub-WSN disclosed by the present invention can solve the problems of limited channel quantity and high power consumption of the WSN in the IoT system in the prior art, and can reduce cost accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a conventional Internet of Things (IoT) system.

FIG. 2 is a simplified block diagram of a sub-WSN for an IoT system having at least a sensor node in accordance with an embodiment of the present invention

FIG. 3 is a simplified block diagram of the sub-gateway in accordance with an embodiment of the present invention.

FIG. 4 is a simplified block diagram of the sub-gateway in accordance with another embodiment of the present invention.

FIG. 5 is a simplified block diagram of the sub-sensor node in accordance with an embodiment of the present invention.

### DETAILED DESCRIPTION

Certain terms are used throughout the description and following claims to refer to particular components. As one skilled in the art will appreciate, manufacturers may refer to a component by different names. This document does not intend point to distinguish between components that differ in name but not function. In the following description and in the claims, the terms “include” and “comprise” are used in an open-end pointed fashion, and thus should be interpreted to mean “include, but not limited to”. Also, the term “couple” is intend pointed to mean either an indirect or direct electrical coupling. Accordingly, if one device is coupled to another device, that coupling may be through a direct electrical coupling, or through an indirect electrical coupling via other devices and couplings.

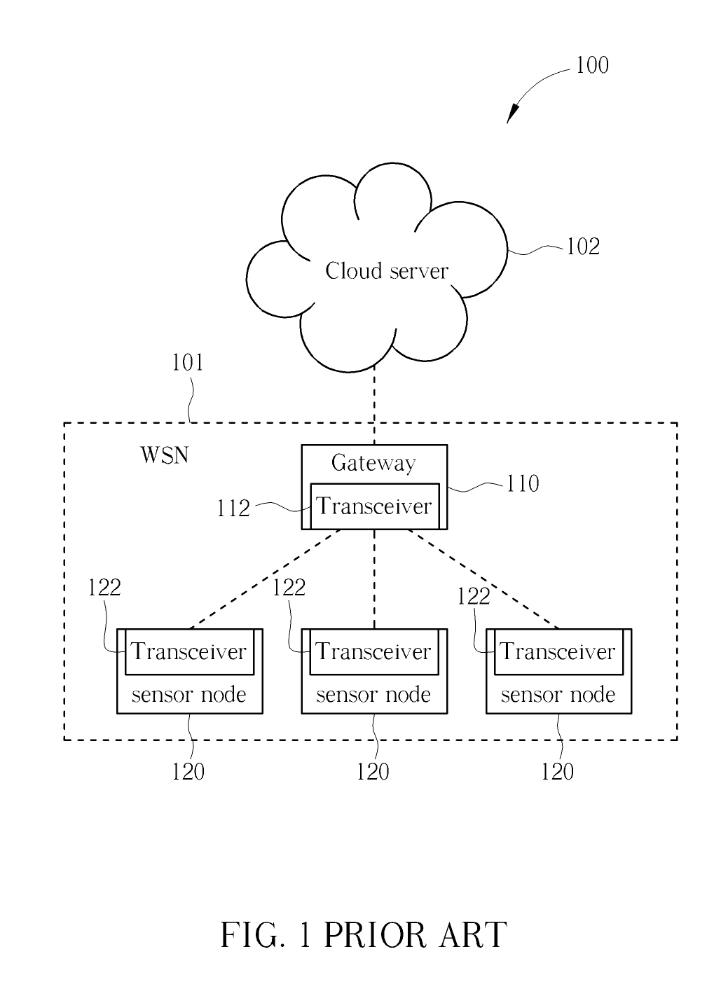

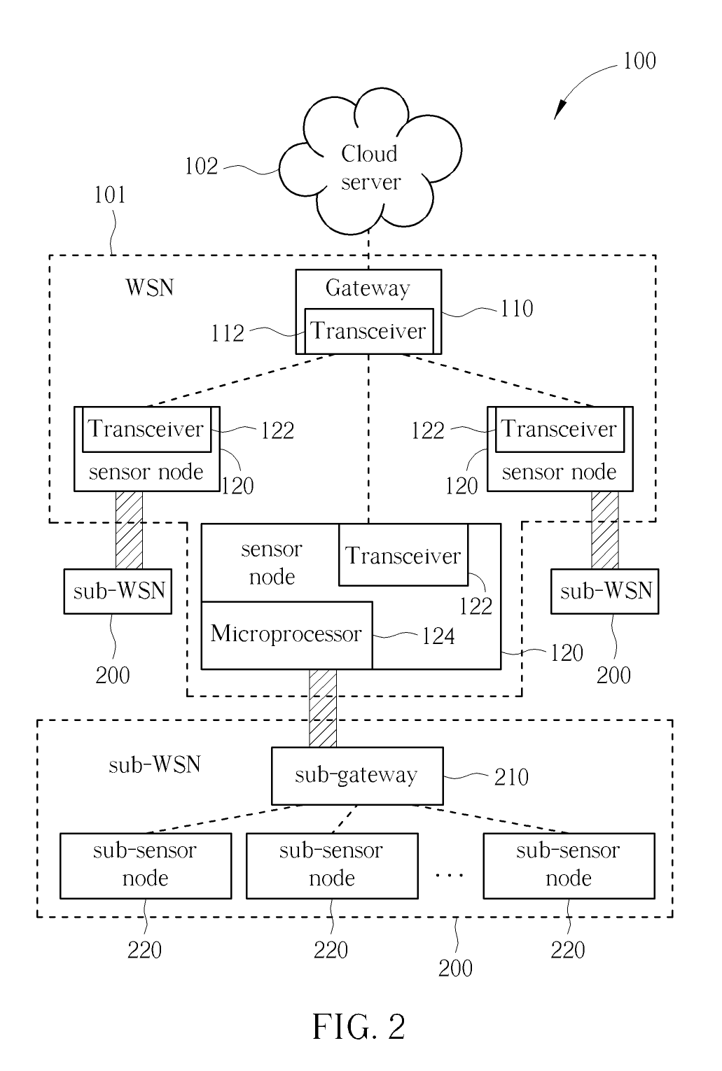

Please refer to FIG. 2. FIG. 2 is a simplified block diagram of a sub-WSN 200 for the IoT system 100 having the sensor nodes 120 in accordance with an embodiment of the present invention, wherein the elements of the IoT system 100 are illustrated in FIG. 1. For example, the sensor node 120 can be a Bluetooth device, a ZigBee device, a WiFi device, a 6LowPAN device, a LoRa device, or a Sub-1 GHz device, etc. As shown in FIG. 2, the sensor node 120 comprises a transceiver 122 and a microprocessor 124, and the sub-WSN 200 comprises: a sub-gateway 210 and ten sub-sensor nodes 220, wherein the sub-sensor nodes 220 can be wireless sensors such as wireless temperature sensors, wireless thermal sensors, wireless optical sensors, wireless pressure sensors, wireless environment sensors, or wireless acoustic sensors, etc. Herein, please note that the above embodiment is only for an illustrative purpose and is not meant to be a limitation of the present invention. For example, the number and functions of the sub-gateway 210 and the sub-sensor nodes 220 can be changed according to different design requirements. The sub-gateway 210 is wiredly coupled to the Sensor node 120, and the sub-sensor nodes 220 are utilized for sensing and wirelessly communicating with the sub-gateway 210 via Radio Frequency (RF) signals, wherein a wire coupling between the sub-gateway 210 and the sensor node 120 is a serial coupling or a parallel coupling comprising a Serial Peripheral Interface bus (SPI), an Inter Integrated Circuit bus (I2C), or a Universal Asynchronous Receiver Transmitter (UART), and a wireless communication between the sub-gateway 210 and the sub-sensor nodes 220 is a low power proprietary RF transceiver architecture such as a sub-1 GHz proprietary RF transceiver architecture (for example, a 27 MHz proprietary RF transceiver architecture). Thus, the sub-WSN 200 is an ultra low power sub-WSN. Specifically, please note that the sub-gateway 210 is externally and wiredly coupled to the microprocessor 122 of the sensor node 120 and operates without using the transceiver 124 of the sensor node 120 since the transceiver 124 causes the problem of high power consumption.

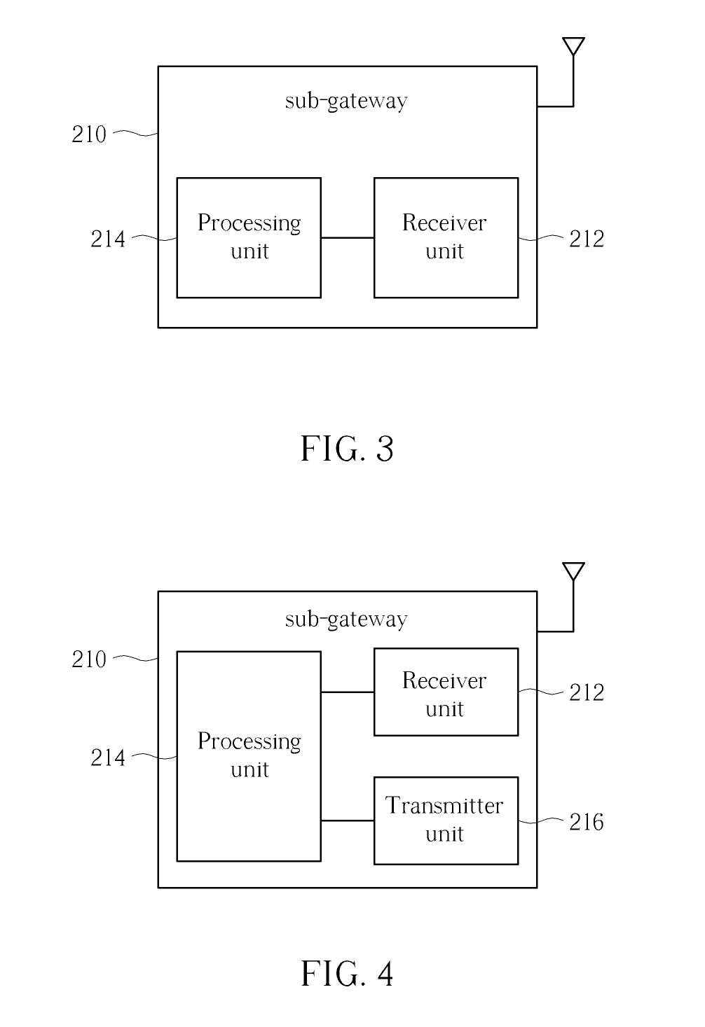

Please refer to FIG. 3. FIG. 3 is a simplified block diagram of the sub-gateway 210 in accordance with an embodiment of the present invention. As shown in FIG. 3, the sub-gateway 210 comprises a receiver unit 212 and a processing unit 214, wherein the power consumption of the sub-gateway 210 can be very low (for example, lower than 1 micro watt). The receiver unit 212 is utilized for receiving data from the sub-sensor nodes 220 of the sub-WSN 200. The processing unit 214 is coupled to the receiver unit 212, and utilized for processing the data, wherein the processing unit 214 can be a microprocessor or a state machine. Specifically, the processing unit 214 is utilized for decoding the data so as to provide the decoded data for the sensor node 120. In addition, the processing unit 214 has a serial or parallel wire coupling for connecting the sensor node 120 in an IoT system, and the serial or parallel wire coupling can be utilized for externally controlling settings or debug. Herein, please note that the above embodiment is only for an illustrative purpose and is not meant to be a limitation of the present invention. For example, please refer to FIG. 4. FIG. 4 is a simplified block diagram of the sub-gateway 210 in accordance with another embodiment of the present invention. As shown in FIG. 4, the sub-gateway 210 can comprise a transmitter unit 216. The transmitter unit 216 is coupled to the processing unit 214, and utilized for transmitting signals to the sub-sensor nodes 220. In addition, since the power consumption of the sub-gateway 210 can be very low (for example, lower than 1 micro watt), the sub-gateway 210 can further comprises a power harvesting circuit for obtaining required power from environment without using any battery. For example, the power harvesting circuit can be a RF power harvesting circuit for obtaining the required power from RF.

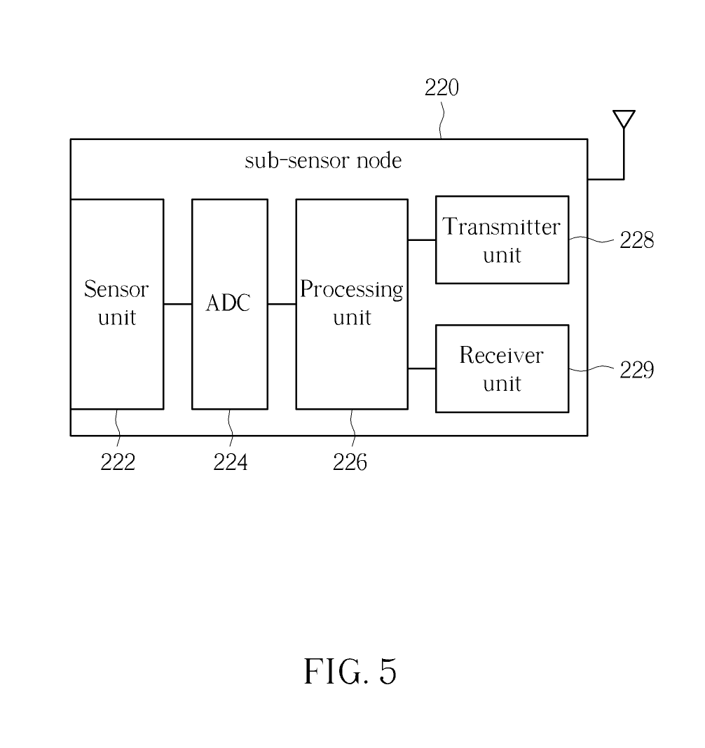

Next, please refer to FIG. 5. FIG. 5 is a simplified block diagram of the sub-sensor node 220 in accordance with an embodiment of the present invention. As shown in FIG. 5, the sub-sensor node 220 comprises: a sensor unit 222, an analog-to-digital converter (ADC) 224, a processing unit 226, a transmitter unit 228, and a receiver unit 229, wherein the power consumption of the sub-sensor node 220 also can be very low (for example, lower than 1 micro watt). The sensor unit 222 is utilized for sensing to generate sensing values. The ADC 224 is coupled to the sensor unit 222, and utilized for converting the sensing values. The processing unit 226 is coupled to the ADC 224, and utilized for processing the sensing values to generate data, wherein the processing unit 226 can be a microprocessor or a state machine. Specifically, the processing unit 214 is utilized for encoding the sensing values to generate the data and provide the data to the transmitter unit 228. In addition, the processing unit 226 can determine operation time of the sensor unit 222, the transmitter unit 228, and the receiver unit 229, so as to reduce the power consumption efficiently. Moreover, the processing unit 214 can have a serial or parallel wire coupling for externally reading the sensing values or debug. The transmitter unit 228 is coupled to the processing unit 226, and utilized for transmitting the encoded data to the sub-gateway 210 of the sub-WSN 200. The receiver unit 229 is coupled to the processing unit 226, and utilized for receiving signals from the sub-gateway 210 of the sub-WSN 200. Herein, please note that the above embodiment is only for an illustrative purpose and is not meant to be a limitation of the present invention. For example, the sub-sensor node 220 can further comprises a power harvesting circuit for obtaining required power from environment without using any battery since the power consumption of the sub-sensor node 220 can be very low (for example, lower than 1 micro watt). For example, the power harvesting circuit can be a RF power harvesting circuit for obtaining the required power from RF.

For example, when the IoT system 100 is applied to sense temperature of a number N of solar panels and N=20, the present invention can provide a sub-WSN 200 having two sub-gateways 210 and twenty sub-sensor nodes 220 for a sensor node 120 of the WSN 101 in the IoT system 100. Please note that the wireless communication between the sub-gateway 210 and the sub-sensor nodes 220 is an ultra low power proprietary RF transceiver architecture such as a 27 MHz proprietary RF transceiver architecture, which uses different frequency from standard RF in WSN 101 and has more flexible channels for transmission. Besides, the power consumption of the sub-gateway 210 and the sub-sensor nodes 220 can be very low (for example, lower than 1 micro watt). Therefore, the sub-WSN 200 can be applied to battery-less applications (for example, RF power harvest only can generate 1˜10 uW and can support the sub-gateway 210 and the sub-sensor nodes 220 in the sub-WSN 200). In this way, only one sensor node 120 is required for this scenario, and thus the problems of limited channel quantity and high power consumption of the WSN 101 in the IoT system 100 in the prior art are solved by this ultra low power sub-WSN 200. Briefly summarized, the ultra low power sub-WSN, and the sub-sensor node and the sub-gateway for the sub-WSN disclosed by the present invention can solve the problems of limited channel quantity and high power consumption of the WSN in the IoT system in the prior art, and can reduce cost accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sub-wireless sensor network (sub-WSN) for an Internet of Things (IoT) system having at least a sensor node, comprising:
a sub-gateway, wiredly coupled to the sensor node; and
a plurality of sub-sensor nodes, for sensing and wirelessly communicating with the sub-gateway via RF signals.

2. The sub-WSN of claim 1, wherein a wire coupling between the sub-gateway and the sensor node is a serial coupling or a parallel coupling comprising a Serial Peripheral Interface bus (SPI), an Inter Integrated Circuit bus (I2C), or a Universal Asynchronous Receiver Transmitter (UART).

3. The sub-WSN of claim 1, wherein a wireless communication between the sub-gateway and each sub-sensor node is a sub-1 GHz proprietary RF transceiver architecture.

4. The sub-WSN of claim 1, wherein each sensing device comprises a power harvesting circuit for obtaining required power from environment.

5. A sub-sensor node for a sub-WSN, comprising:
a sensor unit, for sensing to generate sensing values;
a processing unit, coupled to the sensor unit, for processing the sensing values to generate data;
a transmitter unit, coupled to the processing unit, for transmitting the data to a sub-gateway of the sub-WSN; and
a receiver unit, coupled to the processing unit, for receiving signals from the sub-gateway of the sub-WSN.

6. The sub-sensor node of claim 5, wherein the processing unit is a microprocessor or a state machine.

7. The sub-sensor node of claim 5, wherein the processing unit determines operation time of the sensor unit, the transmitter unit, and the receiver unit.

8. The sub-sensor node of claim 5, wherein the processing unit is utilized for encoding the sensing values to generate the data.

9. The sub-sensor node of claim 5, wherein the processing unit has a serial or parallel wire coupling for externally reading the sensing values or debug.

10. The sub-sensor node of claim 5, wherein further comprises a power harvesting circuit for obtaining required power from environment.

11. A sub-gateway for a sub-WSN, comprising:
a receiver unit, for receiving data from a plurality of sub-sensor nodes of the sub-WSN; and
a processing unit, coupled to the receiver unit, for processing the data.

12. The sub-gateway of claim 11, wherein the processing unit is utilized for decoding the data.

13. The sub-gateway of claim 11, wherein the processing unit has a serial or parallel wire coupling for connecting a sensor node in an IoT system.

14. The sub-gateway of claim 11, wherein the processing unit has a serial or parallel wire coupling for externally controlling settings or debug.

15. The sub-gateway of claim 11, further comprising:
a transmitter unit, coupled to the processing unit, for transmitting signals to the sub-sensor nodes.

16. The sub-gateway of claim 11, wherein the processing unit is a microprocessor or a state machine.
